(19) United States
(12) Patent Application Publication
(10) Pub. No.: US 2009/0242114 A1
(43) Pub. Date: Oct. 1, 2009

(54) RECORDING MATERIAL AND METHOD FOR MANUFACTURING PRINTED MATTER USING THE SAME

(75) Inventor: Shigeki Nishimura, Shiba (JP)

Correspondence Address: DARBY & DARBY P.C., P.O. BOX 770, Church Street Station, New York, NY, 10008-0770, US

(73) Assignee: MITSUBISHI PLASTICS, INC., Tokyo (JP)

(21) Appl. No.: 12/094,842

(22) PCT Filed: Dec. 1, 2006
(86) PCT No.: PCT/JP2006/324116

§ 371 Date: Jul. 29, 2008

(51) Int. Cl. B32B 38/14; B41M 5/52

(52) U.S. Cl. 156/277; 428/32.1

(57) ABSTRACT

The present invention provides a recording material comprising a plastic layer and an ink receiving layer sequentially laminated on a supporting body in such a manner that the supporting body and the plastic layer are delaminatable. By having such a structure, the recording material enables high-quality printing even when printing such as inkjet printing is performed on a substrate which is composed of a resin other than PVC. It also exhibits excellent scratch resistance and tamper resistance. The invention also provides a method for easily and productively manufacturing a printed matter or a card using such a recording material.

### TECHNICAL FIELD

The present invention relates to a recording material and a manufacturing method of printed matter using the same.

### BACKGROUND ART

In general, image recording media such as credit card and ID card are manufactured by a method such as combination of serigraph, offset printing, and photographs. In recent years, the image recording media is manufactured by giving sublimation transfer printing to materials like a substrate of polyvinyl chloride series resin (hereinafter, refer to as “PVC”.); thereby the method enables to easily and quickly manufacture such an image recording media. For example, Patent document 1 discloses a card in which receiving layer consisting of polyvinyl chloride and so on is given sublimation transfer printing and having a hardened layer consisting of ultraviolet curable resin composition on the surface layer.

### Patent Document 1: Japanese Patent Application Laid-Open (JP-A) No. 07-032774

### DISCLOSURE OF THE INVENTION

### Problems to be Solved by the Invention

However, the sublimation transfer printing method needs to use an expensive manufacturing manufacturing facility and has a necessity to protect the surface of the card as scratch resistance of the print side is insufficient. Moreover, in recent years, in view of environmental protection, kinds of substrate to be used for cards is varied from PVC to polyethylene terephthalate series resin (hereinafter, refer to as “PET”.) and the like. Compared with PVC substrate, giving sublimation transfer printing to the PET substrate is difficult, and printing as high-quality as that to PVC substrate cannot be realized.

In addition, a method, wherein printing is made by inkjet method and thereafter the printed matter is adhered to a card, can be alternative. However, adhesion is necessary through adhesive and cutting process is necessary for cutting the printed matter along the card shape. Further, considering actual use of the cards at the stage of distribution, a layer for protecting the surface of the card is required. Therefore, if inkjet method is adopted, complex processes are necessary based on the conventional arts, and satisfactory recording material in terms of its productivity cannot be obtained.

Accordingly, an object of the present invention is to provide a recording material which enables high-quality printing even when printing such as inkjet printing is performed thereon and which exhibits excellent scratch resistance. Another object of the present invention is to provide a method for easily and productively manufacturing a printed matter using the recording material.

### Means for Solving the Problems

The present invention will be described as follows. In order to make the understanding of the present invention easier, reference numerals of the attached drawings are quoted in brackets; however, the present invention is not limited by the embodiment shown in the drawings.

The first aspect of the present invention is a recording material (10) comprising: a supporting body (3); and a plastic layer (2) and an ink receiving layer (1) sequentially laminated on the supporting body (3) in such a manner that the supporting body (3) and the plastic layer (2) are delaminatable.

According to this invention, the ink receiving layer (1) exists at the outermost layer of the recording material (10) consisting of the supporting body (3), the plastic layer (2), and the ink receiving layer (1). Since the ink receiving layer particularly enables to absorb the ink well, by recording with ink on the surface of ink receiving layer (1), it is capable to obtain a sharp image.

In addition, in the recording material (10) of the invention, adhesive strength A between the supporting body (3) and the plastic layer (2) is smaller than adhesive strength B between the plastic layer (2) and the ink receiving layer (1) (adhesive strength A<adhesive strength B). Therefore, it is possible to easily peel the supporting body (3) only from the recording material (10) or a printed matter (100) in which the recording material (10) is fusedly adhered to the substrate (4).

Moreover, since recording material (10) has the plastic layer (2) between the ink receiving layer (1) and the supporting body (3), after peeling the supporting body (3) from the recording material (10), the plastic layer (2) works as a surface protecting layer for the ink receiving layer (1) as the recording layer, further the recording material can obtain scratch resistance and tamper resistance.

In the first aspect of the invention, melting point of a resin constituting the ink receiving layer (1) is preferably 40° C. or more and 100° C. or less. In this constitution, the resin constituting the ink receiving layer (1) has low-melting point. So, by superposing the substrate (4) on the surface of ink receiving layer (1) as the recording surface and heating the both, it is capable to easily fuse the recording material to the substrate (4) without using adhesives.

In the first aspect of the invention, thickness of the laminated portion (5) of the plastic layer (2) and the ink receiving layer (1) is preferably 25 μm or less.

In this constitution, the laminated portion (5) including the plastic layer (2) and the ink receiving layer (1) is extremely thin. Thereby, when the substrate (4) is fusedly adhered to the ink receiving layer (1) side of the recording material (10), then, the ink receiving layer (1) and the plastic layer (2) are peeled from the side of supporting body (3), these layers (the ink receiving layer and the plastic layer) can be easily cut along the shape of the substrate (4).

Also, even if the ink receiving layer (1) and the plastic layer (2) may be attempted to be separated from each other, as the laminated portion (5) formed by these two layers is only 25 μm thick, it is in fact almost impossible. And, even if the temperature is raised for weakening the adhesive strength between these layers to destroy the interlayer bonding, as the laminated portion (5) is a thin layer and has weak stiffness, the layer becomes swelling or shrinking by heating and cooling at the time of peeling. Therefore, reproductivity of the image cannot be obtained. Thus, tamper resistance of the laminated portion (5) consisting of the plastic layer (2) and the ink receiving layer (1) can be enhanced.

In the first aspect of the invention, the plastic layer (2) is formed by a single resin selected from a group consisting of polymethyl methacrylate, polymethyl acrylate, polystyrene, polycarbonate, and polyethylene terephthalate, or blended resin of two or more kinds thereof, or ultraviolet curable resin. Hereinafter, polymethyl methacrylate may be abbreviated as PMMA, polymethyl acrylate may be abbreviated as PMA, polystyrene may be abbreviated as PS, polycarbonate may be abbreviated as PC, and polyethylene terephthalate may be abbreviated as PET.

In the constitution, it is possible to enhance the transparency of the plastic layer (2) that works as a surface protecting layer after peeling of the supporting body (3) from the recording material (10); it is also possible to make the image of the ink receiving layer (1) as the recording face arranged underneath the plastic layer (2) easily viewable. In addition, these resin materials has relatively high hardness so that it is capable to enhance the capability as the surface protecting layer. Moreover, when polyethylene (hereinafter, it may be abbreviated as “PE”.), polypropylene (hereinafter, it may be abbreviated as “PP”.), and the like are used as the supporting layer (3), peeling becomes easy.

In the first aspect of the invention, the plastic layer (2) is preferably formed by PMMA.

In this constitution, since PMMA has both relatively high hardness and also brittleness, when both the ink receiving layer (1) and the plastic layer (2) are peeled from the supporting body (3), it becomes further easier to cut these layers (the ink receiving layer and the plastic layer) along the shape of the substrate (4).

In the first aspect of the invention, to total mass of the plastic layer (2) as 100 parts by mass, 2 parts by mass or more and 50 parts by mass or less of inorganic filler or organic microparticles (21) is preferably added to the plastic layer (2).

In the constitution, by adding the inorganic filler or organic microparticles (21) to the plastic layer (2), flexibility of the plastic layer (2) can be reduced and a plurality of breaking points can be easily formed. So, after fusing the substrate (4) to the recording material (10), the plastic layer (2) can be cut along the shape of substrate (4). Once the plastic layer (2) is cut into the predetermined shape, the ink receiving layer (1) which is integrally laminated to the plastic layer (2) can also be easily cut in the same shape.

The above inorganic filler (21) to be added to the plastic layer (2) is preferably silica. In the constitution, silica to be used as an inorganic filler is transparent so that the image printed to the ink receiving layer through the plastic layer as a surface protecting layer can be observed in the vivid state.

In the first aspect of the present invention, the ink receiving layer (1) is formed by containing a resin represented by the following general formula (1) as the main component.

-[A¹X¹A¹R¹]- (1)

In the general formula (1), X¹ is a residue of an organic compound having two or more active hydrogen groups; R¹ is a residue of a dicarboxylic acids compound or a residue of a diisocyanate series compound; and A¹ is represented by the following general formula (2).

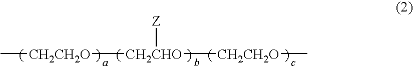

In the general formula (2), Z is a hydrocarbon group of carbon number 1 or more; “a”, “b”, and “c” are respectively integer numbers of 1 or more; and mass ratio calculated by the following formula using “a”, “b”, and “c”:

{44(a+c)/(molecular weight of α-olefinoxide of which carbon number is 3 or more)×b}

is 80/20 or more and 94/6 or less.

The wording “as the main component” means that the resin represented by the above general formula (1), to total mass of the entire ink receiving layer (1), is contained preferably 50 mass % or more, more preferably 90 mass % or more, furthermore preferably 98 mass % or more.

In the constitution, the ink receiving layer (1), which is formed by containing the resin of the above general formula (1) as the main component, can be thermally fusedly adhered to the substrate (4) with ease when PET is used as the substrate (4). In addition, the ink receiving layer (1) of the constitution can be easily formed into a film with thickness of some micrometers; by having such an ink receiving layer (1) being adhered with the plastic layer (2) formed into a film with similar thickness, it is capable to make a recording material which has tamper resistance and cut-ability along the shape of the substrate.

In the first aspect of the invention, printing method to the ink receiving layer (1) is not limited unless it is influential to the ink receiving layer (1). As the printing method, there may be inkjet method, thermal transfer method, laser exposure thermal development-transfer method, and electrophotographic method using laser and LED. Among these, for the printing method to an ink receiving layer (1), it is preferable to adopt inkjet method. By adopting this method, it is capable to economically obtain a high-quality image on the recording material (10).

The second aspect of the present invention is a method for manufacturing printed matter (100) comprising the steps of: forming a print side on an ink receiving layer (1) of the recording material (10) described in the first aspect of the invention; adhering a substrate (4) having a predetermined shape onto the print side; and breaking the plastic layer (2) along the predetermined shape of the substrate and peeling a laminated body consisting of the substrate (4), the ink receiving layer (1), and the plastic layer (2) from the supporting body (3).

According to the second aspect of the invention, the ink receiving layer (1) and the plastic layer (2) both can be easily cut along the shape of substrate (4) and can be peeled from the supporting body (3), thereby it is capable to form a printed matter (100) which exhibits excellent scratch resistance and tamper resistance.

### BRIEF DESCRIPTION OF THE DRAWINGS

FIG. 1 is a schematic cross-sectional view showing the constitution of the recording material;

FIGS. 2(a)˜2(c) are schematic views showing the manufacturing process of printing matter; and

FIG. 3 is a schematic view showing an example of the manufacturing process of the plastic card.

### DESCRIPTION OF THE REFERENCE NUMERALS

1 ink receiving layer
2 plastic layer
3 supporting body
4 (card) substrate
21 inorganic filler or organic microparticles
10 recording material
100 printed matter (laminated body)
200 (plastic) card
500 plastic card manufacturing equipment

### BEST MODE FOR CARRYING OUT THE INVENTION

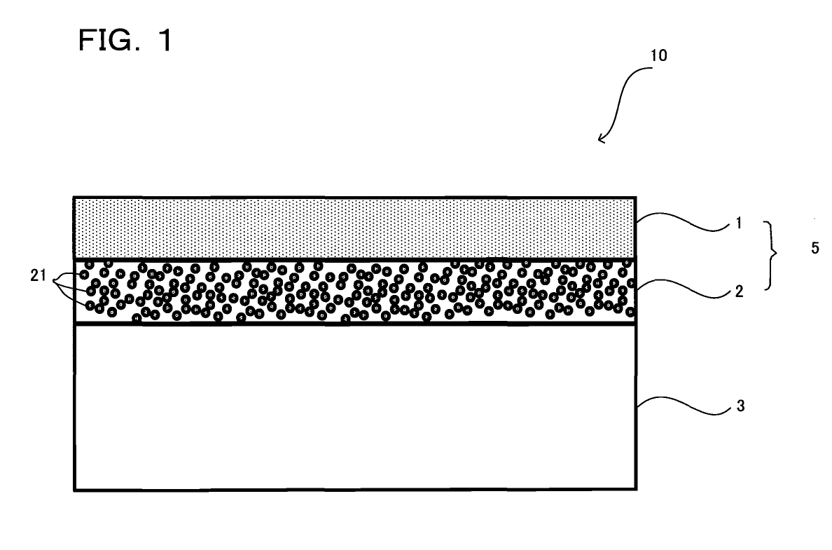

As shown in FIG. 1, the recording material 10 of the present invention consists of a supporting body 3, a plastic layer 2 laminated on the supporting body 3, and an ink receiving layer 1 arranged thereon. In the invention, a portion, where the plastic layer 2 and the ink receiving layer 1 are laminated, is called “laminated portion 5”. Also, below-mentioned “printed matter (laminated body)” 100 is a product in which the (card) substrate 4 is fusedly adhered to the ink receiving layer 1 side of this “laminated portion” 5.

<Supporting Body 3>

As a material to be used for the supporting body 3, it is not particularly limited if the material has high flatness and the surface thereof is suitable for application, and if the material is the one which can be easily peeled from the plastic layer 2 without damaging the plastic layer 2. Specific examples of the material used for the supporting body 3 include resins such as polyethylene (PE), polypropylene (PP), ethylene vinyl acetic acid copolymer (EVA), mold-releasable polyethylene terephthalate, acidly modified polyolefin, and syndiotactic polystyrene. As the mold-releasable polyethylene terephthalate, a polyethylene terephthalate sheet that mold-releasing property is given to the surface by silicone application or fluoride process can be used.

Since these resins have flexibility, when peeling the supporting body 3 made of these resins from the adjacent plastic layer 2, it is possible to reel the supporting body 3 to a roll and the like such that the supporting body 3 to be bent; thereby peeling process becomes simple and easy. Among these materials, in view of peelability, material cost, and commercial availability, polyethylene (PE) or polypropylene (PP) is preferably used; while, in view of control of adhesive force, acidly modified polyolefin is preferably used.

Moreover, thickness of the supporting body 3 is preferably 30 μm or more, more preferably 50 μm or more, at the lower limit. While, thickness of the same is preferably 250 μm or less, more preferably 100 μm or less, at the upper limit. If thickness of the supporting body 3 is too thin, predetermined stiffness cannot be maintained; thereby, in the manufacturing process, the supporting body 3 may be deflected or be elongated in the longitudinal direction by tension of winding with rolls and the like. Thus, it is not preferable. Moreover, if thickness of the supporting body 3 is too thick, the supporting body 3 becomes unnecessarily bulky when it is wound in coil state, which is not preferable, either.

<Plastic Layer 2>

As the physical property required for resins used for plastic layer 2, it is preferable to have more than predetermined value of hardness and melting point because of the requirement of functions as the surface protecting layer when peeled from the supporting layer 3 later on. Specifically, from the practical point of view, the melting point is preferably 80° C. or more.

The materials constituting the plastic layer 2 are not particularly limited as long as it can be easily peeled from the supporting body 3 and is a resin of high transparency. For example, there may be polymethyl methacrylate (PMMA), polymethyl acrylate (PMA), polystyrene (PS), polycarbonate (PC), polyethylene terephthalate (PET), or blended resin thereof, ultraviolet curable resin, or electron-ray curable resins. Among these, from the viewpoint of resin having both relatively high hardness and also brittleness, ultraviolet curable resin, polymethyl methacrylate, and polystyrene are preferable.

As the ultraviolet curable resin and electron-ray curable resins, for instance, there may be resins obtained by adequately mixing various acrylate monomers and other additives into a material mainly containing oligomers such as urethan acrylate and epoxy acrylate and by preparing the handleability, workability, curability, and so on. Moreover, certain dosage of photopolymerization initiators such as benzoin series, acetophenone series, thioxanthone series, and peroxide series photopolymerization initiator may be added to preferably carry out curing polymerization.

The plastic layer 2 preferably includes inorganic filler or organic microparticles 21 (see FIG. 1), the lower limit of the dosage thereof, to total mass of the plastic layer (100 parts by mass), is 2 parts by mass or more, preferably 5 parts by mass or more, more preferably 8 parts by mass or more. While, the upper limit of the dosage thereof, to total mass of the plastic layer (100 parts by mass), is 50 parts by mass or less, preferably 30 parts by mass or less, more preferably 20 parts by mass or less. By containing the inorganic filler or organic microparticles 21 within the above range in the plastic layer 2, when the recording material 10 and the card substrate 4 are fusedly adhered and then the supporting body 3 is peeled therefrom, breaking point can be formed in the plastic layer 2, thus it is easy to shape the plastic layer 2 to be transferred to the substrate 4 side along the shape of the substrate 4.

When dosage of the inorganic filler or organic microparticles 21 is too small, sufficient filling effect cannot be obtained. On the other hand, when dosage of the inorganic filler or organic microparticles 21 is excessive, mechanical property of the plastic layer 2 becomes brittle; thereby the plastic layer 2 is not able to sufficiently work as the surface protecting layer, which is not preferable.

As the organic microparticles 21 contained in the plastic layer 2, there may be microparticles of polymer containing fluororesin such as polytetrafluoroethylene micropowder. Also, as inorganic filler 21, in view of formation of the breaking points, silica, titanium oxide, talc, glass beads, ceramic powder, and the like may be used. In order to keep transparency of the plastic layer 2, preferably, the inorganic filler 21 is clear and colorless but also has a refractive index near to that of resin used for the plastic layer. Further, it is preferably porous so as to absorb ink for printing which reaches the plastic layer 2 by penetrating the ink receiving layer 1. From the above viewpoint, as the inorganic filler 21, silica is most preferably used among the above examples.

<Ink Receiving Layer 1>

As a main component of the resin constituting the ink receiving layer 1, for instance, there may be thermoplastic resin, the typical examples may include polyalkyleneoxide, aqueous polyester series resin, aqueous polyurethane resin, cellulose series compound, and modified compounds thereof. These may be used alone or in combination of two or more thereof. Moreover, to the extent where the adhesive force at a time of fusion bonding is maintainable, polyvinyl acetate (PVA), polyvinyl pyrrolidone (PVP), and so on may be blended and used.

From the viewpoint of having the main component resin being able to maintain the adhesive force, the included main component, to total mass of the ink receiving layer (1) (100 mass %), is preferably 50 mass % or more, more preferably 90 mass % or more, furthermore preferably 98 mass % or more.

As the resin to be used for the ink receiving layer 1, so as the ink receiving layer 1 to fusedly adhere the substrate 4 with ease, the melting point needs to be 100° C. or less. In addition to this, in view of heat resistance and image saving of the ink receiving layer 1 at the point of use, the melting point is preferably 40° C. or more.

The main component of the resin constituting the ink receiving layer 1 may preferably be a water-absorbent resin capable to be made into a film by dry method such as extrusion forming which is excellent in productivity. As the water-absorbent resin as such, for example, polyethylene oxide is suitably used. Further, in the invention, a hydrophilic thermoplastic resin constituted of the repeating units represented by the following general formula (1) may be preferably used as a main component for constituting the ink receiving layer 1.

-[A¹X¹A¹R¹]- (1)

In the general formula (1), X¹ is a residue of an organic compound having two or more active hydrogen groups. Examples thereof include ethylene glycol, propylene glycol, bisphenol-A, aniline propylene glycol, and polytetramethylene glycol. R¹ is a residue of a dicarboxylic acids compound or a residue of a diisocyanate series compound. As the dicarboxylic acids compound, for instance, cyclic dicarboxylic acid compound or straight-chain dicarboxylic acid compound may be desirable; dicarboxylic acid, dicarboxylic acid anhydride, and lower alkyl esters of dicarboxylic acid may be the specific examples.

Examples of the above dicarboxylic acid include phthalic acid, isophthalic acid, terephthalic acid, malonic acid, succinic acid, sebacic acid, maleic acid, fumaric acid, adipic acid, and itaconic acid. As the above dicarboxylic acid anhydride, there may be anhydrides of the above various dicarboxylic acids. Further, examples of lower alkyl esters of the above dicarboxylic acid include methylester, dimethylester, ethylester, diethylester, propylester, and dipropylester of the above various dicarboxylic acids. A straight-chain dicarboxylic acid of carbon number 12˜36 and the lower alkyl esters thereof are particularly preferably used. 1,10-decamethylene dicarboxylic acid, 1,14-tetradecamethylene dicarboxylic acid, 1,18-octadecamethylene dicarboxylic acid, and 1,32-dotriacontanemethylene dicarboxylic acid may also be preferably used.

Examples of the above lower alkyl esters include methylester, ethylester, propylester, and dipropylester of these dicarboxylic acids. These may be used alone or in combination of two or more thereof. Among these, in view of ease of reaction, the above dicarboxylic acid anhydride and lower alkyl esters of the dicarboxylic acid may be preferably used.

Examples of diisocyanate series compound include 4,4-diphenylmethane diisocyanate, toluene diisocyanate, xylylene diisocyanate, isophorone diisocyanate, and methylene bis-cyclohexyl diisocyanate. These may be used alone or in combination of two or more thereof.

A¹ is represented by the following general formula (2).

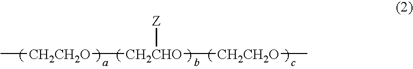

In the general formula (2), Z is a hydrocarbon group of carbon number 1 or more, which gives a function of hydrophobicity to the resin composition represented by the general formula (1) For instance, it is preferably an alkyl group such as methyl group, ethyl group, propyl group. “a”, “b”, and “c” are respectively integer number of 1 or more; and mass ratio calculated by the following formula using “a”, “b”, and

{44(a+c)/(molecular weight of α-olefinoxide of which carbon number 3 or more)×b}

is 80/20 or more and 94/6 or less. When the mass ratio is less than 80/20, hydrophilicity of A¹ declines; ink absorbent and printability of the same are also inferior. On the other hand, when the mass ratio is over 94/6, it is inferior in terms of water-resistance of blurred ink. If the ratio of “a”, “b”, and “c” is set within the above range, it is capable to prevent from loosing hydrophilicity and to insoluble to water.

The thermoplastic resin can be obtained in accordance with the following procedures. Firstly, ethylene oxide is reacted with ethylene glycol by addition polymerization; alkyleneoxide is also reacted to the above product by addition polymerization; then, to a polyalkyleneoxide obtained by the above addition polymerization of ethylene oxide, dicarboxylic acid compound or diisocyanate compound is reacted to generate the thermoplastic resin.

<Optional Additive Components to Each Layer>

In the recording material 10 of the present invention, for the purpose of improving blur-resistance and fixing property of the ink, cationic polymer may be contained. Layers to which the cationic polymer is added are not particularly limited; it may be contained in one of the ink receiving layer 1 or the plastic layer 2, or in both of the layers. Examples of the cationic polymer suitably used for the recording material 10 of the invention include copolymer consisting of monomer having quaternarized amino group such as polyallylamine hydrochloride, polyalkyl aminoacrylate, and the like. In these polymers, the melting point (Tm) is preferably within the range of 60-200° C., and the molecular weight is also preferably within the range of 1000-100,000.

In the invention, content of the cationic polymer, to total mass (100 mass %) of the layers to be added, is preferably around 5˜50 mass %. When content of the cationic polymer is 5 mass % or more, it is capable to effectively inhibit blur of the ink.

In the invention, in the range which does not undermine the properties of the invention, various additives such as antioxidant, and ultraviolet inhibitor can be further contained in the ink receiving layer 1 and the plastic layer 2. For instance, so as to prevent heat deterioration at a time of melt-extrusion, antioxidant may be contained in the resin composition. Dosage of the antioxidant to be added for improving thermal stability, to the mass (100 mass %) of the entire layers to which the antioxidant is added, is suitably around 0.3˜1.5 mass %.

<Thickness of Each Layer>

Thickness of the laminated portion 5 having the ink receiving layer 1 and the plastic layer 2 of the present invention is preferably 25 μm or less, more preferably 20 μm or less, furthermore preferably 15 μm or less, and most preferably 12 μm or less. Also, thickness at the lower limit of the ink receiving layer 1 is preferably 5 μm or more; while, thickness of the same at the upper limit is preferably 14 μm or less, more preferably 10 μm or less.

Moreover, thickness of the plastic layer 2 is preferably 1 μm or more at the lower limit; thickness of the same at the upper limit is preferably 20 μm or less, more preferably 10 μm or less. The ratio of thickness between the ink receiving layer 1 and the plastic layer 2, with regard to the cutting carried out after fusion bonding of the substrate layer 4 is preferably within the range of 1:0.5˜1:1.5 (the ink receiving layer 1: the plastic layer 2) in view of cut-ability.

When thickness of the ink receiving layer 1 is too thin, the ink receiving layer 1 cannot absorb sufficient amount of ink at a time of printing, which makes it difficult to obtain vivid image; thereby it is not preferable. While, when thickness of the ink receiving layer 1 is too thick, cutting the laminated layers along the card substrate becomes difficult; thus, this is not preferable, either.

While, when thickness of the plastic layer 2 is too thin, mixing the inorganic filler and organic microparticles 21 becomes difficult; thereby it is not preferable. Moreover, when thickness of the plastic layer 2 is too thick, cutting the laminated layers along the card substrate 4 becomes difficult; thus, this is not preferable, either.

Further, if total thickness of the ink receiving layer 1 and the plastic layer 2 becomes over 25 μm, breaking strength of the laminated portion 5 becomes high, tamper becomes easy, and cutting of these layers becomes difficult; thus it is not preferable. By setting thickness of the laminated portion 5 and each layer to the above range, tamper resistance is improved and the card production becomes easier.

<Manufacturing Method-1: Printed Matter (Laminated Body) 100>

The recording material 10 of the present invention is manufactured by laminating the plastic layer 2 and the ink receiving layer 1 sequentially to the supporting body 3. The lamination method is not specifically limited; for example, when the supporting body 3 is a resin, the recording material 10 may be formed by the following method: a resin as the ink receiving layer 1, a resin as the plastic layer 2, and a resin as the supporting body 3 are respectively blended and optionally pelletized; the resins for each layers are fed into T-die extruder for melting and co-extruded; then, the co-extruded layer is cooled to solidify by using cooling rolls, water-cooler, air-cooler, and so on to form the recording material 10 of the invention.

Alternatively, the recording material 10 may be formed by directly extrude the resin as the plastic layer 2 and the resin as the ink receiving layer 1 from T-die to the prefabricated supporting body 3; or it may be formed by forming each layer in advance by use of extruder, later, sequentially laminating the layers. When the plastic layer 2 is ultraviolet curable resin, the recording material 10 may be easily manufactured by coating ultraviolet curable resin by gravure coating method and the like to the ink receiving layer 1 or the supporting body 3 which is processed in a form of film in advance, then by hardening the ultraviolet curable resin by ultraviolet radiation, later, by laminating the rest of layers thereon.

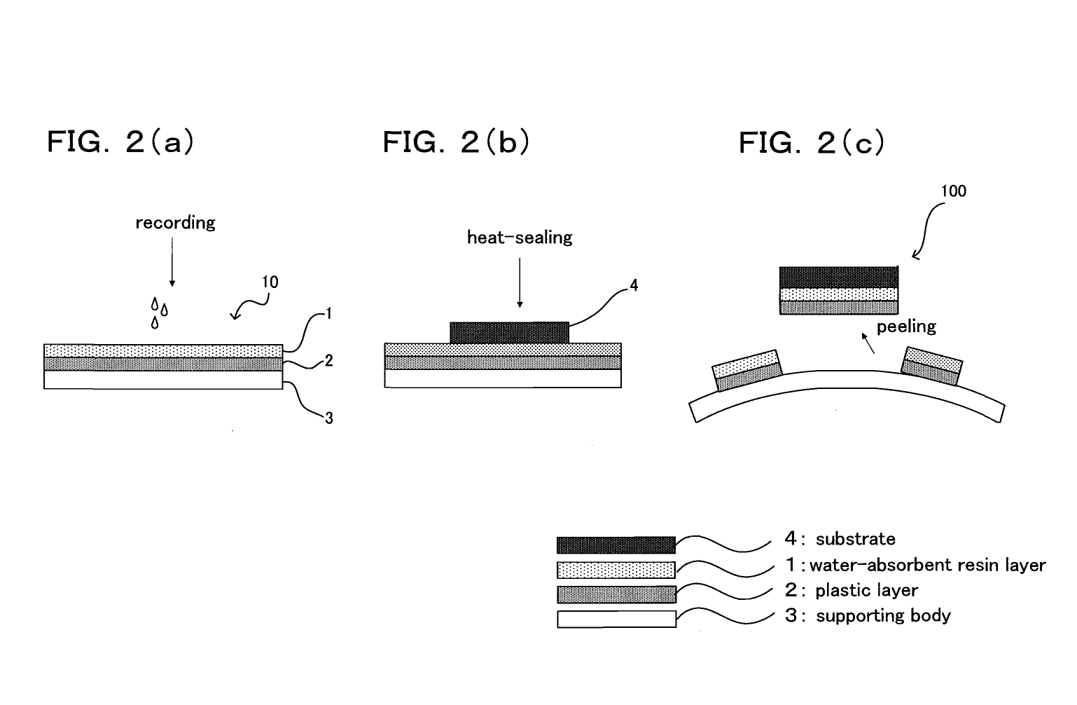

FIG. 2 shows a method for manufacturing a printed matter (laminated body) 100 using the recording material 10 of the present invention. In the recording material 10 of the invention, as shown in FIG. 2(a), images or the like can be printed on the upper surface of ink receiving layer 1. The printing method is not particularly limited as long as it does not affect the ink receiving layer; for instance, inkjet method, thermal transfer method, method of laser exposure thermal development and transfer, electrophotographic method by using laser and LED, and so on may be adopted. Among thermal transfer method, method of laser exposure thermal development and transfer, and electrophotographic method by using laser and LED, it is preferable to adopt a method in which rolls adjacent to the ink receiving layer do not becomes too hot. In such printing methods, water-based ink is preferably used, and inkjet method is preferably adopted.

In the recording material 10 of the invention, after recording on the surface of the ink receiving layer 1, as shown in FIG. 2(b), placing the substrate 4 on the upper surface of the ink receiving layer 1 and carrying out heat-sealing can be done. The substrate 4 to be used for the invention is not particularly limited as long as it is the one to which the resin forming the ink receiving layer 1 can heat-seal; for example, PET and biodegradable resins may be used. Examples of the biodegradable resins include microbial acidic polyester such as 3-hydroxy butyric acid-3-hydroxy valeric acid copolymer; starch-polyvinyl alcohol resin complex; thermoplastic resin mainly containing polylactic acid copolymer or lactic acid-oxycarboxylic acid copolymer; aliphatic polyester such as polycaprolactone; and so on.

As the substrate 4, surface-treated paper, metal sheet, ceramic sheet, and so on for heat-sealing may be used.

Among them, the substrate 4 of the invention, in view of commercial availability, cost, workability, and heat-sealing property to the water-absorbent resin, PET is preferably used. Size of the substrate 4 is not specifically limited; size of like from business card to B3-size or more may be used without limitation. Specific examples of method for heat-sealing include press method, nip method using heat rolls, hot wind compression method, and so on.

After the heat-sealing, by adding stress to the substrate 4 to peel the substrate 4 from the recording material 10, as shown in FIG. 2(c), the supporting body layer 3 is peeled, simultaneously, the plastic layer 2 is broken along the shape of substrate 4. Infectiously, the ink receiving layer 1 also simultaneously broken in the same shape, the ink receiving layer 1 and the plastic layer 2 fusedly adhered to the substrate 4 are separated from the supporting body layer 3. By having the above steps, the ink receiving layer 1 and the plastic layer 2 are laminated sequentially onto the substrate 4 to form the printed matter (laminated body) 100. In the invention, since a certain amount of predetermined inorganic fillers or organic microparticles is contained in the plastic layer 2, the plastic layer 2 is easily broken along the shape of the substrate 4 and occurrence of burr when broken is inhibited.

Moreover, by making the half-cut on the recording material 10 of the invention in the thickness direction (i.e. the laminated portion 5 only is cut, but the supporting layer 3 is not cut.) in arbitrary shape, then the half-cut portion is heat-sealed to the substrate 4 and the supporting layer 3 is peeled therefrom; and a printing layer and a protecting layer can be formed on the substrate 4 of only in a particular area where the half-cut portion is fusedly adhered. By doing this, it is also possible to form, in the remaining area, a printed matter (laminated body) 100 which enable to accept processing such as serigraph and sticking of magnetic tape, and etc. In the invention, by using the plastic layer 2 of the above form, as the plastic layer 2 is broken along the shape of the substrate 4, it is possible to form a predetermined shape of the printed matter 100 without making half-cut.

<Manufacturing Method-2: Plastic Card 200>

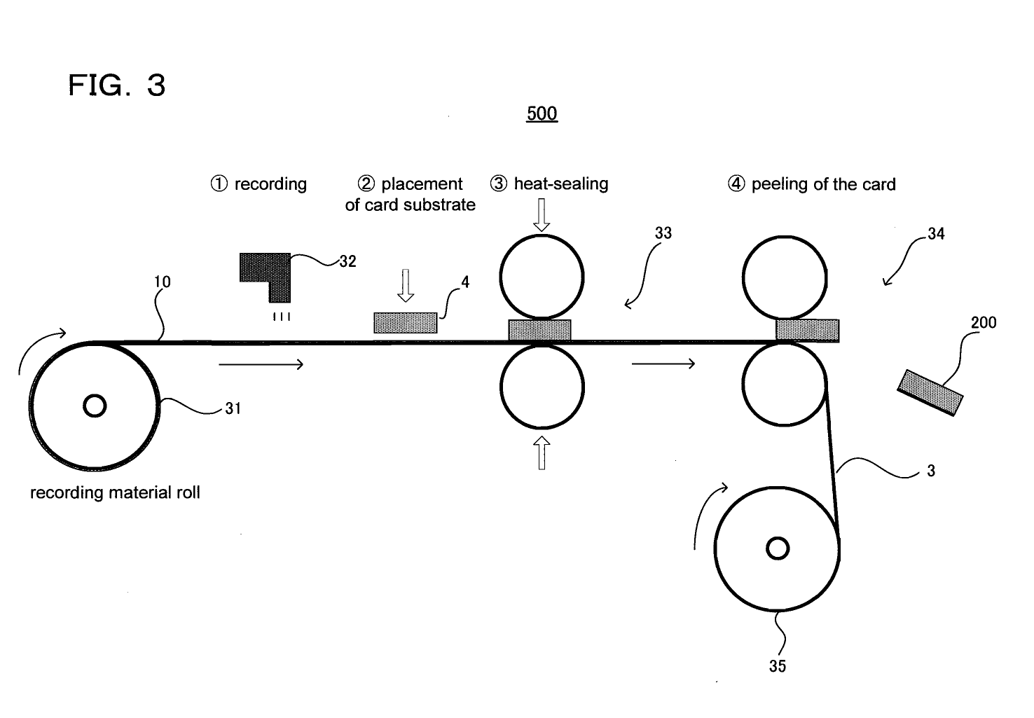

FIG. 3 shows an example of manufacturing equipment of a plastic card 200 using the recording material 10 of the present invention. The manufacturing equipment 500 of the plastic card 200 comprises: a recording material roll 31 in which the recording material 10 is reeled in advance in the longitudinal direction; a printing means 32 for printing predetermined images on an ink receiving layer 1 side of the recording material 10 rewound from the recording material roll 31; card substrate arranging means (not shown) for arranging the card substrate 4 on the upper surface of the ink receiving layer 1 on which images are printed; heat-sealing means 33 for heat-sealing the card substrate 4 (in this embodiment, it is formed by a plastic material) arranged on the ink receiving layer 1 and the ink receiving layer 1; a peeling means 34 for peeling the supporting body 3 from the recording material 10 and the card substrate 4 both of which are integrally formed by heat-sealing; and a winding reel 35 for winding the peeled supporting body 3.

According to the manufacturing equipment 500 of the plastic card 200 shown in FIG. 3, by sequentially feeding the recording material 10, the step for printing on the outer surface of the ink receiving layer 1 of the recording material 10 and the step for fusedly adhering the card substrate 4 on the printed surface of the ink receiving layer 1 can be performed by in-line process. Further, as shown in FIG. 3, by bending the recording material 10 integrally fusedly adhered with the substrate 4 in a different direction from the direction to the flat surface of the card substrate 4, not only the supporting body 3 can be peeled from the recording material 10 by the stiffness of the card substrate 4, but also among the three layers constituting the recording material 10, the ink receiving layer 1 and the plastic layer 2 can be peeled along the shape of card substrate 4. Therefore, there is no need for cutting the card edge by die-cut and the like. As seen above, by use of the manufacturing equipment 500 of the plastic card 200 shown in FIG. 3, it is capable to simply and continuously manufacture the plastic card 200 on which a certain image is recorded by use of the recording material 10 of the invention and the card substrate 4.

The usages of the plastic card 200 thus manufactured include ID card, credit card, debit card, deposit card, reward card, various membership cards, commuter pass, patient registration card for medical institutions, cards for buying food at company cafeteria, setting board, ruler, stationary goods like triangular ruler, product list, and menu sheet for the use of franchised restaurant. Furthermore, if required, magnetic recording part or IC chips may be provided to inside or back side of the substrate 4.

### EXAMPLES

### Preparation of Samples for Evaluation

### Example 1

Ethylene oxide was reacted with ethylene glycol by addition polymerization; then, butylene oxide was added thereto and polymerized; ethylene oxide was further added thereto and polymerized; and octadecane-1,18-methyl dicarboxylic acid was added to the obtained polyalkyleneoxide by the above addition polymerization to carry out the ester exchange reaction. To 100 parts by mass of the sample of which weight-average molecular weight 150,000 thus obtained, 1 part by mass of tocophenol (“UVINUL 2000AO” manufactured by BASF Corporation) was added as a thermal stabilizer to obtain Sample A to be the ink receiving layer. The melting point of Sample A was 65° C.

Next, to 100 parts by mass of acrylic resin (“GR-F” manufactured by KURARAY Co., Ltd.), 10 parts by mass of silica was added and compounded by a biaxial extruder, then it was palletized to obtain Sample B to be the plastic layer.

Samples A and B thus obtained by the about process, and polystyrene resin (“HF77” manufactured by A&M styrene Co., Ltd.) to be the supporting body were made into a film by melt-coextruding forming using multi-manifold dies, and the recording material was obtained. Thickness of the ink receiving layer (Sample A) was 5 μm, of the plastic layer (Sample B) was 5 μm, and of the supporting body (polystyrene resin) was 30 μm.

Onto the ink receiving layer side of the recording material manufactured by the above method, an image data (fanciful name, ID number, address, and facial portrait) at 300 dpi was printed by specular printing by use of “Deskjet 1120C” manufactured by Hewlett-Packard Company. Thereafter, a white PET card substrate with a size of 5 cm×10 cm was placed on the formed print side and thermally laminated at 80° C., 3 m/min. Finally, the supporting body was peeled to make the plastic card. In addition, to the recording material of Example 1, printing was carried out with “Indigo 4050” manufactured by Hewlett-Packard Company (liquid toner type electrophotographic printing method). Same as the above manner, the plastic card was made. In the same case, similar result was obtained.

### Example 2

Except for changing the thickness of each layer to 10 μm for the ink receiving layer (Sample A), 10 μm for the plastic layer (Sample B), and 30 μm for the supporting body (polystyrene resin), a plastic card was formed in the same manner as Example 1.

### Example 3

A mixture having 50 parts by mass of hard coating liquid of ultraviolet curable resin (ultraviolet curable resin (“KAYARAD D-310” manufactured by Nippon Kayaku Co., Ltd.), 3 parts by mass of photopolymerization initiator (“IRGACURE 184” manufactured by Ciba Speciality Chemicals), and 50 parts by mass of solvent (2-propanol) were prepared and coated onto 50 μm thick mold-releasable PET (“Purex” manufactured by Teijin DuPont Films) as the supporting body by gravure coating method so as the dried thickness of the mixture to become 5 μm (Sample C).

At the same time as film making by melt-extruding forming with manifold dies, extrusion lamination for laminating the same water-absorbent resin (Sample A) as the one used in Example 1 in molten state onto the hard coating surface of Sample C was carried out. Thickness of each layer was set to 5 μm for the ink receiving layer (Sample A), 5 μm for the plastic layer (Sample C), and 50 μm for the supporting body (mold-releasable PET).

Onto the recording material manufactured by the above method, an image data (fanciful name, ID number, address, and facial portrait) at 300 dpi was printed by specular printing by use of “Deskjet 1120C” manufactured by Hewlett-Packard Company. Thereafter, a white PET card substrate with a size of 5 cm×10 cm was placed on the formed print side and thermally laminated, then the supporting body was peeled to make a plastic card.

### Example 4

In Example 1, except for having a material (in which 10 parts by mass of silica was added to 100 parts by mass of polystyrene resin (“HF77” manufactured by A&M styrene Co., Ltd.), was compounded by a biaxial extruder, and then was palletized) as the sample of the plastic layer, a recording material and a plastic card were formed in the same manner as Example 1.

### Comparative Example 1

By using the sublimation transfer printer (“PR5200” manufactured by NISCA Corporation), the same image data which was printed in Example 3 was printed to the PVC card substrate by sublimation transfer printing. As a reference, by sublimation transfer printing, printing could not be done onto the same white PET card substrate as those of which used for Examples 1 and 2.

### Comparative Example 2

The same image data as the one printed in Example 3 was printed to the inkjet media (transparent) manufactured by Pictorico Corporation by specular printing; adhesive (“Bond first 7M” manufactured by Sumitomo Chemical Co., Ltd.) was applied on the print side; then, it was adhered to the same white PET card substrate as those of which used for Examples 1 and 2.

### Comparative Example 3

To the surface treated by corona discharge treatment of a 38 μm thick PET film (“ES100” ester film manufactured by TOYOBO Co., Ltd.) as the supporting body, an acrylic resin (“DIANAL FR-4867” acrylic resin manufactured by Mitsubishi Rayon Co., Ltd.) as the plastic layer was applied by using a doctorbar so as the thickness to become 5 μm, and dried it at 110° C. Later, the same water-absorbent resin (Sample A) as the one printed in Example 1 was made into a film by melt-extruding forming using multi-manifold dies, simultaneously, extrusion lamination for laminating Sample A onto the above plastic layer in molten state was carried out to form a 25 μm thick ink receiving layer.

Next, onto the ink receiving layer, an image data (fanciful name, ID number, address, and facial portrait) at 300 dpi was printed by specular printing by use of “Deskjet 1120C” manufactured by Hewlett-Packard Company. Thereafter, a white PET card substrate with a size of 5 cm×10 cm was placed on the printed ink receiving layer and thermally laminated at 80° C., 3 m/min. Finally, the supporting body was peeled to make the plastic card.

<Evaluation of the Cards Above>

Cards made in accordance with the above Examples and Comparative examples were evaluated based on the following evaluation items. The evaluations results are shown in Table 1.

### (1) Image Quality

The image made on the white card was visually observed.

◯ (good): No spread or blurred dots can be found, the image is clear;

X (bad): There are some spread and blurred dots, and the image is not clear.

### (2) Tamper Resistance

A card on which an image was made was put into the oven, and the surface protecting layer was peeled under 100° C. ambient atmosphere. While, in Comparative example 1, the image was printed on the upper surface once more by sublimation transfer printing.

### (3) Appearence

A card was visually observed from the card surface with respect to the defects such as coloration, trapped air

### (4) Production Workability

Simplicity of workability during the steps for manufacturing cards was recorded.

### (5) Scratch Resistance (Scratch Test)

When a test sample is scratched by finger nails strongly,

◯ (good): No scratching can be found;

Δ (not bad): Some concaves can be found as the scratching;

X (bad): As the scratching, inside is white or some concaves caused by unevenness.

### (6) Condition of Transfer

Condition of transfer was comprehensively evaluated by visual observation, finger scratching, and so on.

<3> Evaluation Results

Table 1

TABLE 1

| | Image | Tamper | | | Scratch | |
|---|---|---|---|---|---|---|
| | quality | resistance | Appearance | Production workability | resistance | Condition of transfer |
| Example 1 | ∘ | Peeling could be | The image and the substrate | It is possible to be | Δ | Adhesiveness with the |
| | | done and image | were closely adhered so that | simply manufactured by | | substrate was no problem. |
| | | was damaged. | the white color of the substrate | thermal lamination. As | | No burr was caused during |
| | | | could be seen clearly that | lamination can be done | | the peeling of the supporting |
| | | | results in excellent color | at lower temperature, | | body. Adhesiveness at the |
| | | | contrast and bright color. | thermal damage to the | | peripheral area of the card |
| | | | Visibility of the image was | card is small and | | was good. No damage was made |
| | | | also good. | warpage was not seen. | | when scratcing the surface, |
| | | | | | | thereby the image did |
| | | | | | | not have any troubles. |
| Example 2 | ∘ | Peeling could | The image and the substrate | It is possible to be | Δ | Adhesiveness with the |
| | | be done but | were closely adhered so that | simply manufactured by | | substrate was no problem. |
| | | tamper could | the white color of the substrate | thermal lamination. As | | No burr was caused during |
| | | also be done | could be seen clearly that | lamination can be done | | the peeling of the supporting |
| | | to the certain | results in excellent color | at lower temperature, | | body. Adhesiveness at the |
| | | extent. | contrast and bright color. | thermal damage to the | | peripheral area of the card |
| | | | Visibility of the image was | card is small and | | was good. No damage was made |
| | | | also good. | warpage was not seen. | | when scratcing the surface, |
| | | | | | | thereby the image did |
| | | | | | | not have any troubles. |
| Example 3 | ∘ | Peeling could | The image and the substrate | It is possible to be | ∘ | Adhesiveness with the |
| | | be done and | were closely adhered so that | simply manufactured by | | substrate was no problem. |
| | | image was | the white color of the substrate | thermal lamination. As | | No burr was caused during |
| | | damaged. | could be seen clearly that | lamination can be done | | the peeling of the supporting |
| | | | results in excellent color | at lower temperature, | | body. Adhesiveness at the |
| | | | contrast and bright color. | thermal damage to the | | peripheral area of the card |
| | | | Visibility of the image was | card is small and | | was good. No damage was made |
| | | | also good. | warpage was not seen. | | when scratcing the surface, |
| | | | | | | thereby the image did |
| | | | | | | not have any troubles. |
| Example 4 | ∘ | Peeling could be | The image and the substrate | It is possible to be | Δ | Adhesiveness with the |
| | | done and image | were closely adhered so that | simply manufactured by | | substrate was no problem. |
| | | was damaged. | the white color of the substrate | thermal lamination. As | | No burr was caused during |
| | | | could be seen clearly that | lamination can be done | | the peeling of the supporting |
| | | | results in excellent color | at lower temperature, | | body. Adhesiveness at the |
| | | | contrast and bright color. | thermal damage to the | | peripheral area of the card |
| | | | Visibility of the image was | card is small and | | was good. No damage was made |
| | | | also good. | warpage was not seen. | | when scratcing the surface, |
| | | | | | | thereby the image did |
| | | | | | | not have any troubles. |
| Comparative | ∘ | New image coud | Visibility of the image was | Since printing was the | Δ | Although it is not image |
| example 1 | | be reproduced | good. The white color of the | only process, card | | transfer, the printed image |
| | | by one more | card could be seen clearly so | production was | | was peeled when scratching |
| | | sublimation | that the contrast of the image | extremely simple. | | the surface of the card. |
| | | transfer printing. | was excellent, thereby the | | | |
| | | | image was bright. | | | |
| Comparative | ∘ | Peeling could be | The white color of the substrate | Positioning of the media | x | Peeling of the supporting |
| example 2 | | done but tamper | seemed dull through the adhesive | to stick to a substrate | | body was not possible |
| | | could also be | layer. Contrast was low and | through adhesive was | | because the peripheral |
| | | done. | the image was dark. | difficult. | | area was unbreakable. So, |
| | | | | | | the laminated layers was |
| | | | | | | punched out in card shape |
| | | | | | | by using Tomson cutter. |
| Comparative | ∘ | Peeling could be | The image and the substrate | It is possible to be | Δ | Adhesiveness is no problem, |
| example 3 | | done and image | were closely adhered so that | simply manufactured by | | but, when peeled, burr was |
| | | was damaged. | the white color of the substrate | thermal lamination. As | | occurred at the peripheral |
| | | | could be seen clearly that | lamination can be done | | area of the card. Peeling |
| | | | results in excellent color | at lower temperature, | | between the ink receiving |
| | | | contrast and bright color. | thermal damage to the | | layer and the card substrate |
| | | | Visibility of the image was | card is small and | | was also caused. |
| | | | also good. | warpage was not seen. | | |

In Examples 1˜4 of the present invention, overall, favorable results were shown in any evaluation items. In Example 2, since laminated portion consisting of the ink receiving layer and the plastic layer has a certain thickness, evaluation result of the tamper resistance was slightly inferior. In Examples 1, 2, and 4, since an acrylic resin or a polystyrene resin was used as the plastic layer, compared with the case where ultraviolet curable resin is used in Example 3, the scratch resistance thereof was slightly inferior. In Example 3, although inorganic filler and the like were not included in the plastic layer, as the plastic layer itself is easily broken, no burr was caused when peeling the supporting body.

In Comparative example 1, as sublimation transfer printing was simply done on the surface of a PVC card substrate, the scratch resistance was inferior. Further, by giving sublimation transfer printing once more on the surface, tamper could be easily done. In addition to this, since material of the substrate was PVC, it was not preferable in view of environmental protection.

As Comparative example 2 is a case where printing was given to a conventional inkjet media, peeling the printed layer from the substrate was easily done; thereby tamper was also easily done. Moreover, such a card of Comparative example 2 was made by adhering the printed layer to the substrate by use of adhesive. So, white color of the substrate seemed dull by surface observation through the adhesive layer; thereby visibility of the image was inferior. In addition, positioning for sticking the media on which adhesive was applied to a substrate was difficult; thus the workability was inferior.

In Comparative example 3, because thickness of the ink receiving layer was thick and inorganic filler or organic microparticles was not included in the plastic layer, when peeling the supporting body, the plastic layer and the ink receiving layer were hard to be broken along the shape of the card substrate. Therefore, burr was occurred at the peripheral area of the card; together with this, peeling was caused between the ink receiving layer and the card substrate.

The above has described the present invention associated with the most practical and preferred embodiments thereof. However, the invention is not limited to the embodiments disclosed in the specification. Thus, the invention can be appropriately varied as long as the variation is not contrary to the subject substance and conception of the invention which can be read out from the claims and the whole contents of the specification. It should be understood that a recording material and a method for manufacturing a printed matter using the recording material with such an alternation are included in the technical scope of the invention.

1. A recording material comprising: a supporting body; and a plastic layer and an ink receiving layer sequentially laminated on said supporting body in such a manner that said supporting body and said plastic layer are delaminatable,
wherein thickness of the laminated portion of said plastic layer and said ink receiving layer is 25 μm or less.

2. The recording material according to claim 1, wherein melting point of a resin constituting said ink receiving layer is 40° C. or more and 100° C. or less.

3. The recording material according to claim 1, wherein said plastic layer is formed by a single resin selected from a group consisting of polymethyl methacrylate, polymethyl acrylate, polystyrene, polycarbonate, and polyethylene terephthalate, or blended resin of two or more kinds thereof, or ultraviolet curable resin.

4. The recording material according to claim 1, wherein said plastic layer is formed by polymethyl methacrylate.

5. The recording material according to claim 1, wherein to total mass of said plastic layer as 100 parts by mass, 2 parts by mass or more and 50 parts by mass or less of inorganic filler or organic microparticles is added to said plastic layer.

6. The recording material according to claim 5, wherein said inorganic filler is silica.

7. The recording material according to claim 1, wherein said ink receiving layer is formed by containing a resin represented by the following general formula (1) as the main component.
-[A¹X¹A¹R¹]- (1)
[In the general formula (1), X1 is a residue of an organic compound having two or more active hydrogen groups; R1 is a residue of a dicarboxylic acids compound or a residue of a diisocyanate series compound; and A1 is represented by the following general formula (2). 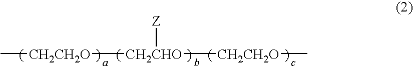
In the general formula (2), Z is a hydrocarbon group of carbon number 1 or more; “a”, “b”, and “c” are respectively integer numbers of 1 or more; and mass ratio calculated by the following formula using “a”, “b”, and “c”:
{44(a+c)/(molecular weight of α-olefinoxide of which carbon number is 3 or more)×b}
is 80/20 or more and 94/6 or less.]

8. The recording material according to claim 1, wherein recording method thereof is inkjet method.

9. Method for manufacturing printed matter comprising the steps of:
forming a print side on an ink receiving layer of said recording material described in claim 1;
adhering a substrate having a predetermined shape on said print side; and
breaking said plastic layer along the predetermined shape of said substrate and peeling a laminated body consisting of said substrate, said ink receiving layer, and said plastic layer from said supporting body.
